(19) United States
(12) Patent Application Publication
(10) Pub. No.: US 2011/0172972 A1
(43) Pub. Date: Jul. 14, 2011

(54) METHOD AND APPARATUS FOR ASSSESSING PROPERTIES OF LIQUIDS BY USING X-RAYS

(75) Inventors: Dan Gudmundson, Quebec (CA); Steve Godbout, L Ancienne-Lorette (CA); Eric Bourbeau, Quebec (CA)

(73) Assignee: OPTOSECURITY INC., Quebec, QC (CA)

(21) Appl. No.: 13/063,869

(22) PCT Filed: Mar. 27, 2009
(86) PCT No.: PCT/CA09/00401

§ 371 Date: Mar. 14, 2011

Related U.S. Application Data
(60) Provisional application No. 61/097,060, filed on Sep. 15, 2008.
(60) Provisional application No. 61/151,242, filed on Feb. 10, 2009.

(51) Int. Cl. G06F 17/50; G06F 7/60

(52) U.S. Cl. 703/1; 703/2

(57) ABSTRACT

A method and a system are provided for determining if a liquid product comprising a container which holds a body of liquid is a security threat. Attenuation data conveying information about attenuation of X-rays resulting from interaction of X-rays with the body of liquid is derived by scanning the liquid product with X-rays. Container characterization data is then processed to derive path length data indicative of an approximate length of a path followed by X-rays through the body of liquid and that interact with the body of liquid. The security threat of a liquid product is determined by processing the path length data and the attenuation data.

### CROSS-REFERENCE TO RELATED APPLICATIONS

For the purpose of the United States, the present application claims the benefit of priority under 35 USC §120 based on:
U.S. provisional patent application Ser. No. 61/151,242 filed on Feb. 10, 2009 by Luc Perron et al. and presently pending.

The present application is also related to:
PCT International Patent Application serial number PCT/CA2008/001721 filed in the Canadian Receiving Office on Sep. 30, 2008 by Michel Roux et al. and presently pending;
PCT International Patent Application serial number PCT/CA2008/002025 filed in the Canadian Receiving Office on Nov. 17, 2008 by Michel Roux et al. and presently pending; and
PCT International Patent Application serial number PCT/CA2007/001658 filed in the Canadian Receiving Office on Sep. 17, 2007 by Dan Gudmundson et al.

The contents of the above-referenced patent documents are incorporated herein by reference.

### FIELD OF THE INVENTION

The present invention relates to technologies for assessing properties of liquids, in particular determining if a liquid presents a security threat. The invention has numerous applications, in particular it can be used for scanning hand carried baggage at airport security check points.

### BACKGROUND OF THE INVENTION

Some liquids or combinations of liquids and other compounds may cause enough damage to bring down an aircraft. As no reliable technology-based solution currently exists to adequately address this threat, authorities have implemented a ban of most liquids, gels and aerosols in cabin baggage.

As a result, there have been disruptions in operations (e.g., a longer screening process; changed the focus for screeners; additional line-ups), major inconveniences for passengers (as well as potential health hazards for some) and economic concerns (e.g., increased screening costs; lost revenues for airlines and duty free shops; large quantities of confiscated—including hazardous—merchandise to dispose of), and so on.

Clearly, there is a need to provide a technology-based solution to address the threat of fluids that are flammable, explosive or commonly used as ingredients in explosive or incendiary devices.

### SUMMARY OF THE INVENTION

In accordance with a broad aspect, the invention provides a method for determining if a liquid product comprising a container which holds a body of liquid is a security threat. The method includes scanning the liquid product with X-rays to derive attenuation data. The attenuation data conveys information about attenuation of X-rays resulting from interaction of X-rays with the body of liquid. The method also includes deriving container characterization data and deriving path length data from the container characterization data. The path length data is indicative of an approximate length of a path followed by X-rays through the body of liquid and that interact with the body of liquid. The method further includes processing the path length data and the attenuation data to determine if the liquid product is a security threat.

In accordance with another broad aspect, the invention provides a method for determining if a liquid product comprising a container which holds a body of liquid is a security threat. The method includes scanning the liquid product with X-rays in a scanning device to derive attenuation data. The attenuation data conveys information about attenuation of X-rays resulting from interaction of X-rays with the body of liquid. The method also includes using a computer to model a position of the liquid product with respect to either one of an X-ray source and an X-ray detector of the scanning device. The method further includes processing the modeled position to compute path length data. The path length data is indicative of an approximate length of a path followed by X-rays through the body of liquid and that interact with the body of liquid. The method also includes processing the path length data and the attenuation data to determine if the liquid product is a security threat.

In accordance with yet another broad aspect, the invention provides an apparatus to determine if a liquid product comprising a container which holds a body of liquid is a security threat. The apparatus includes a device for scanning the liquid product with X-rays to derive attenuation data, the attenuation data conveying information about attenuation of X-rays resulting from interaction of X-rays with the body of liquid. The apparatus also has a processing element having an input for receiving container characterization data, the processing element:
processing the container characterization data for deriving path length data, the path length data being indicative of an approximate length of a path followed by X-rays through the body of liquid and that interact with the body of liquid;
processing the path length data and the attenuation data for determining if the liquid product is a security threat, the processing element having an output for releasing data conveying the result of the determining.

In accordance with another aspect the invention provides an apparatus to determine if a liquid product comprising a container which holds a body of liquid is a security threat. The apparatus including an input for receiving container characterization data and a a computer based processing component. The computer based processing component processing the container characterization data for deriving path length data, the path length data being indicative of an approximate length of a path followed by X-rays through the body of liquid and that interact with the body of liquid. The computer based processing component also processing the path length data and the attenuation data for determining if the liquid product is a security threat. The apparatus also including an output for releasing data conveying the result of the determining.

In accordance with another aspect the invention provides a method for determining the length of a path followed by X-rays through a body of liquid held in a container. The method including scanning the liquid product with X-rays, deriving container characterization data and processing the container characterization data for deriving the length of the path of X-rays during the scanning.

In accordance with yet another aspect the invention provides a method for determining if a liquid product comprising a container which holds a body of liquid is a security threat. The method includes scanning the liquid product with X-rays to derive attenuation data, the attenuation data conveying information about attenuation of X-rays resulting from interaction of X-rays with the body of liquid, generating a virtual model of the container by using a computer and processing the virtual model and the attenuation data to determine if the liquid product is a security threat.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

A detailed description of examples of implementation of the present invention is provided hereinbelow with reference to the following drawings, in which:

FIG. 1 is a flowchart of a process for determining the threat status of a liquid product according to a specific example of implementation of the invention;

FIG. 2 a is a block diagram of an apparatus using X-rays to scan hand carried baggage at a security check point, according to a non-limiting example of implementation of the invention;

FIG. 3 is a more detailed illustration of the X-ray scanner of FIG. 2;

FIG. 4 is a more detailed block diagram of the processing module of the apparatus shown in FIG. 2;

FIG. 5 is graph illustrating the total X-ray attenuation in H2O due to various X-ray matter interactions;

FIG. 6 is a generalized illustration of the photoelectric X-ray absorption process;

FIG. 7 is a generalized illustration of the Compton scattering effect;

FIG. 8 is a diagram of an X-ray image scanner illustrating a method to derive perspective information from X-ray image data according to a specific example of implementation of the invention;

FIG. 9a is a block diagram of an apparatus using an optical camera to generate container characterization data according to a specific example of implementation of the invention;

FIG. 9b is a block diagram of the apparatus using an optical camera of FIG. 9a, according to a variant;

FIG. 10 is a block diagram of an apparatus using a laser scanner to generate container surface definition data according to a specific example of implementation of the invention;

FIG. 11 is a side elevational view of a tray with mechanical contact arms used to grasp a container to obtain container characterization data according to a specific example of implementation of the invention;

FIG. 12 is a simulated X-ray image illustrating the mapping between image portions and individual detectors of the X-ray imaging system according to a specific example of implementation of the invention;

FIG. 13 is a block diagram of an X-ray scanning system that generates X-ray images from two points of view in order to obtain characterization data on the container of a liquid product according to a specific example of implementation of the invention;

FIG. 14 is a flowchart of a process implemented to determine the spatial extent of the container of the liquid product by the processing module of the apparatus shown in FIG. 2;

FIG. 15 is an example of an X-ray image of a set of liquid products;

FIG. 16 is a rendering of a virtual model of a container constructed from characterization data extracted from the X-ray image shown in FIG. 15;

FIG. 17 shows a process performed by the processing module to compute geometrically the path length of X-rays through the body of liquid according to a specific example of implementation of the invention;

FIG. 18 is a top plan view of an X-ray scanner to illustrate a coordinate system according to a specific example of implementation of the invention;

FIG. 19 is a representation of a tray in which the liquid product is held during the X-ray scanning operation according to a specific example of implementation of the invention;

FIG. 20 is a simplified rendering of a virtual model of the scanning area of the X-ray scanner illustrating a specific example of a method of computing path length;

FIG. 21 is a flowchart of a process for determining a cross-sectional shape of the container of the liquid product, according to a non-limiting example of implementation of the invention;

FIG. 22 is a schematical illustration of the container of the liquid product where the X-ray attenuation error distribution is generally uniform;

FIG. 23 is a schematical illustration of the container of the liquid product where the X-ray attenuation error distribution is not uniform;

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

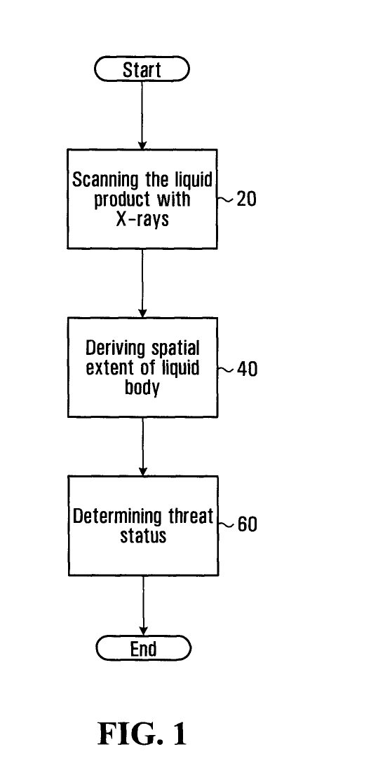

FIG. 1 illustrates a flowchart of a process performed according to a non-limiting example of implementation of the invention for conducting a security screening operation on a liquid product. Note that for the purpose of this specification liquid product is defined as a container holding a liquid. A “liquid” is any product that exhibits a characteristic readiness to flow.

Generally speaking, the process, which can be performed at a security checkpoint or at any other suitable location, would start with step 20, where the liquid product is scanned with X-rays in order to derive attenuation data. The attenuation data conveys information about the interaction of the X-rays with the body of liquid in the liquid product. In a specific and non-limiting example of implementation, the attenuation data is contained in the X-ray image data, which is normally the output of an X-ray scan. Note that “X-ray image” data does not imply that the scanner necessarily produces an X-ray image for visual observation by an observer, such as the operator, on a display monitor. Examples of implementation are possible where the system can operate where the X-ray image data output by the X-ray scanner is not used to create an image on the monitor to be seen by the operator.

At step 40 the process derives a spatial extent of the liquid body. The intent is to determine the length of the path (path length) followed by X-rays through the material during the interaction of the X-rays with the material.

The X-ray path length in combination with the attenuation information can be used at step 60 to determine if the liquid product is a security threat.

1) Scanning the Liquid Product with X-Rays

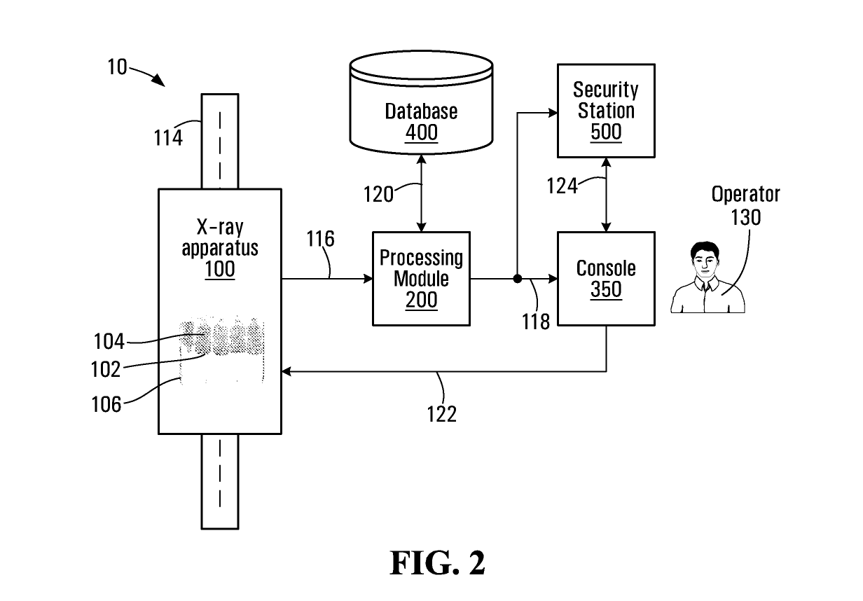

With reference to FIG. 2, there is shown a specific non-limiting example of a system 10 for use in screening containers with liquids, in accordance with a non-limiting embodiment of the present invention. The system 10 comprises an X-ray scanner 100 that applies an X-ray screening process to a liquid 104 contained in a container 102 that is located within a screening area of the X-ray scanner 100. In an airport setting, a passenger may place the container 102 in a tray 106 which is then placed onto a conveyor belt 114 that causes the container 102 to enter the screening area of the X-ray scanner 100. The X-ray scanner 100 outputs an X-ray image data signal 116 to a processing module 200.

The processing module 200 may be co-located with the X-ray scanner 100 or it may be remote from the X-ray scanner 100 and connected thereto by a communication link, which may be wireless, wired, optical, etc. The processing module 200 receives the X-ray image data signal 116 and executes the method briefly described in connection with FIG. 1 to produce a threat assessment 118. The processing module 200 has access to a database 400 via a communication link 120. The processing module 200 may be implemented using software, hardware, control logic or a combination thereof.

The threat assessment 118 is provided to a console 350 and/or to a security station 500, where the threat assessment 118 can be conveyed to an operator 130 or other security personnel. The console 350 can be embodied as a piece of equipment that is in proximity to the X-ray scanner 100, while the security station 500 can be embodied as a piece of equipment that is remote from the X-ray scanner 100. The console 350 may be connected to the security station 500 via a communication link 124 that may traverse a data network (not shown).

The console 350 and/or the security station 500 may comprise suitable software and/or hardware and/or control logic to implement a graphical user interface (GUI) for permitting interaction with the operator 130. Consequently, the console 350 and/or the security station 500 may provide a control link 122 to the X-ray scanner 100, thereby allowing the operator 130 to control motion (e.g., forward/backward and speed) of the conveyor belt 114 and, as a result, to control the position of the container 102 within the screening area of the X-ray scanner 100.

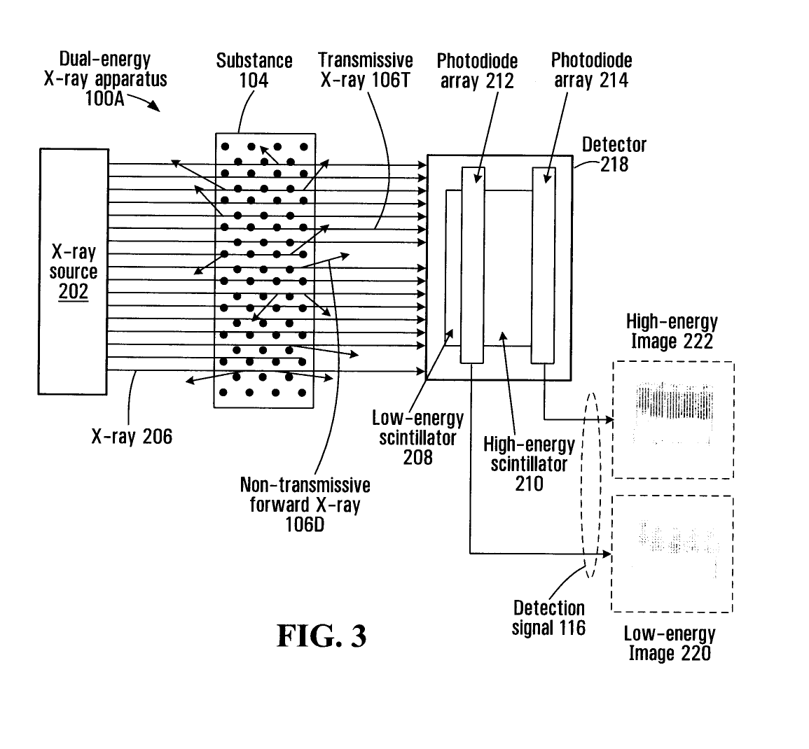

In accordance with a specific non-limiting embodiment, and with reference to FIG. 3, the X-ray scanner 100 is a dual-energy X-ray scanner 100A. However, persons skilled in the art will appreciate that the present invention is not limited to such an embodiment. Continuing with the description of the dual-energy X-ray scanner 100A, an X-ray source 202 emits X-rays 206 at two distinct photon energy levels, either simultaneously or in sequence. Example energy levels include 50 keV (50 thousand electron-volts) and 150 keV, although persons skilled in the art will appreciate that other energy levels are possible.

Generally speaking, X-rays are typically defined as electromagnetic radiation having wavelengths that lie within a range of 0.001 to 10 nm (nanometers) corresponding to photon energies of 120 eV to 1.2 MeV. Although the electromagnetic radiation referred to primarily throughout this description are X-rays, those skilled in the art will appreciate that the present invention is also applicable to electromagnetic radiation having wavelengths (and corresponding photon energies) outside this range.

A detector 218 located generally along an extension of the path of the X-rays 206 receives photons emanating from the combination of the liquid 104 and the container 102 in which it is located. Some of the incoming photons (X-rays 206) will go straight through the container/liquid 104 combination while some will interact with the container/liquid 104 combination. There are a number of interactions possible, such as:
The Rayleigh scattering (coherent scattering)
The photoelectric absorption (incoherent scattering)
The Compton scattering (incoherent scattering)
The pair production;
Diffraction (related to scattering)

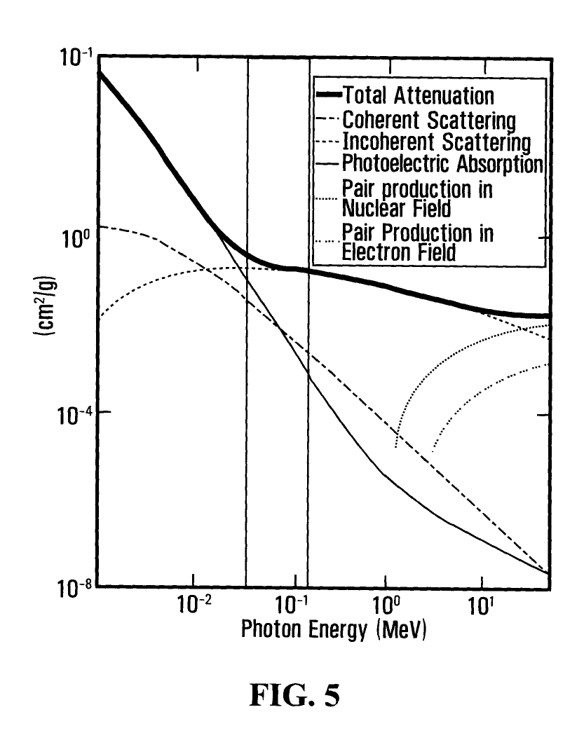

The total attenuation shown in the graph of FIG. 5 is the contribution of the various X-rays—matter interactions. In this example the matter is H₂O but the attenuation profile for other materials is generally similar.

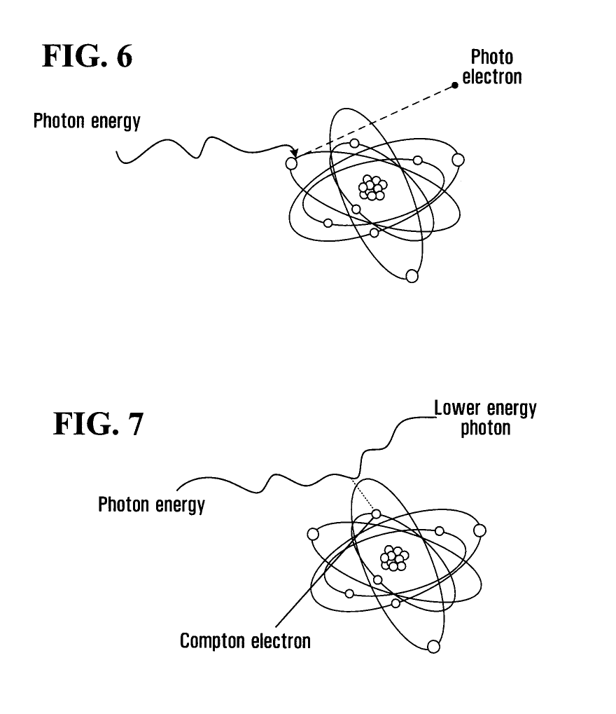

The photoelectric absorption (FIG. 6) of X-rays occurs when the X-ray photon is absorbed, resulting in the ejection of electrons from the shells of the atom, and hence the ionization of the atom. Subsequently, the ionized atom returns to the neutral state with the emission of whether an Auger electron or an X-ray characteristic of the atom. This subsequent X-ray emission of lower energy photons is however generally absorbed and does not contribute to (or hinder) the image making process. This type of X-ray interaction is dependent on the effective atomic number of the material or atom and is dominant for atoms of high atomic numbers. Photoelectric absorption is the dominant process for X-ray absorption up to energies of about 25 keV. Nevertheless, in the energy range of interest for security applications, the photoelectric effect plays a smaller role with respect to the Compton scattering, which becomes dominant.

Compton scattering (FIG. 7) occurs when the incident X-ray photon is deflected from its original path by an interaction with an electron. The electron gains energy and is ejected from its orbital position. The X-ray photon looses energy due to the interaction but continues to travel through the material along an altered path. Since the scattered X-ray photon has less energy, consequently it has a longer wavelength than the incident photon. The event is also known as incoherent scattering, because the photon energy change resulting from an interaction is not always orderly and consistent. The energy shift depends on the angle of scattering and not on the nature of the scattering medium. Compton scattering is proportional to material density and the probability of it occurring increases as the incident photon energy increases.

The diffraction phenomenon of the X-rays by a material with which they interact is related to the scattering effect described earlier. When the X-rays are scattered by the individual atoms of the material, the scattered X-rays may then interact and produce diffraction patterns that depend upon the internal structure of the material that is being examined.

The photons received by the detector 218 include photons that have gone straight through the liquid 104 and the container 102; these photons have not interacted in any significant matter with the liquid 104. Others of the received photons have interacted with the liquid 104 or the container.

In accordance with a specific non-limiting embodiment of the present invention, the detector 218 may comprise a low-energy scintillator 208 and a high-energy scintillator 210, which can be made of different materials. The low-energy scintillator 208 amplifies the intensity of the received photons such that a first photodiode array 212 can produce a low-energy image 220. Similarly, the high-energy scintillator 210 amplifies the intensity of the received photons such that a second photodiode array 214 can produce a high-energy image 222. The low-energy image 220 and the high-energy image 222 may be produced simultaneously or in sequence. Together, the low-energy X-ray image data 220 and the high-energy X-ray image data 222 form the aforesaid X-ray image data signal 116.

Referring back to FIG. 2, the processing module 200 receives the X-ray image data signal 116 and processes the signal in conjunction with data contained in a database 400 to determine if the liquid in the container poses a security threat. The determination can include an explicit assessment as to whether the liquid is a threat or not a threat. Alternatively, the determination can be an identification of the liquid or the class of materials to which the liquid belongs, without explicitly saying whether the liquid is threatening or not threatening. For example, the processing module can determine that the liquid is “water”, hence the operator 130 would conclude that it is safe. In a different example, the processing module 200 determines that the liquid belongs to a class of flammable materials, in which case the operator 130 would conclude that it would be a security threat. Also, the determination can be such as to provide an explicit threat assessment and at the same time also provide an identification of the liquid in terms of general class of materials or in terms of a specific material. The results of the determination are conveyed in the threat assessment signal 118 which is communicated to the console 350 and/or the security station 500 where it is conveyed to the operator 130.

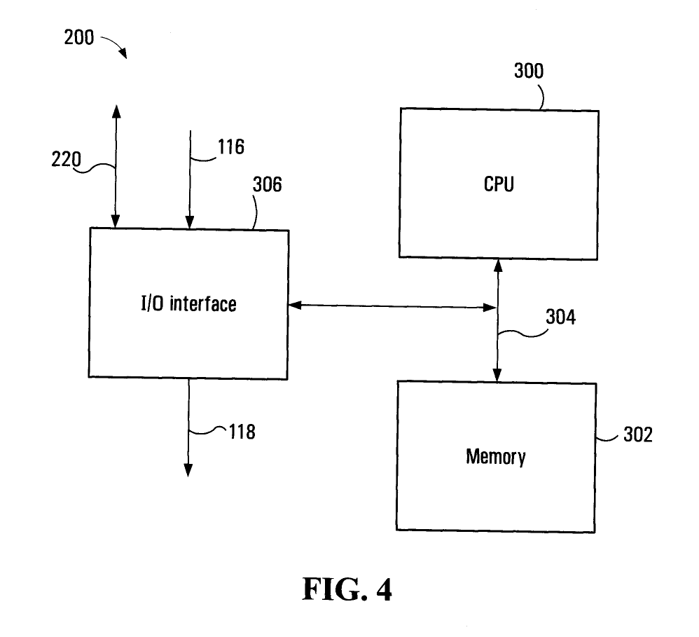

FIG. 4 is a high level block diagram of the processing module 200. The processing module 200 has a Central Processing Unit (CPU) 300 that communicates with a memory 302 over a data bus 304. The memory 302 stores the software that is executed by the CPU 300 and which defines the functionality of the processing module 200. The CPU 300 exchanges data with external devices through an Input/Output (I/O) interface 306. Specifically, the image signal 116 is received at the I/O interface 306 and the data contained in the signal is processed by the CPU 300. The threat assessment signal 118 that is generated by the CPU 300 is output to the console 350 and/or the security station 500 via the I/O interface 306. Also, communications between the database 400 and the processing module 200 are made via the I/O interface 306.

### 2) Determining the Spatial Extent of the Liquid Body

In one specific and non-limiting example of implementation, the spatial extent of the liquid body is determined by looking at the spatial extent of the container. Several possible examples of implementation are possible. These examples are discussed below.

(a) Determining Container Characterization Data by Non-Contact Measurement System

(i) Optical Camera

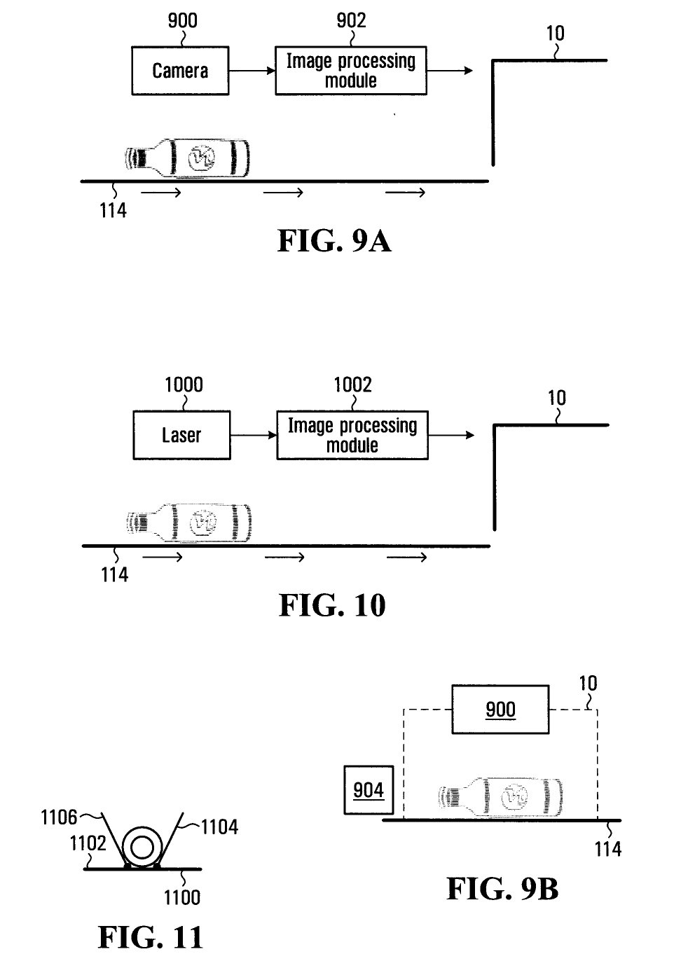

An example of implementation is shown in FIG. 9a. The device shown generates container characterization data from which the spatial extent of the container, along one or more axes can be derived. The device includes an optical camera 900 that takes an image of the liquid product. The image information is conveyed to an image processing module 902 that may be separate from or co-located with the processing module 200. Also, the image processing functionality of the image processing module 902 can be integrated into the functionality of the module 200, by including in the software load of the module 200 the software for performing the image processing.

The image processing module, irrespective of its form of implementation, processes the image information to extract characterization data. The characterization data may include one or more of the following elements:
Approximation of container height;
Approximation of container width
Approximation of container length
Determination of profile of container
Presence or absence of certain surface features such as:
   Annular recesses in container body and position of those annular recesses;
   Presence or absence of cap
   Notches at the bottom of the container

The image processing performed to extract the features described above can be done by using image processing techniques described in International patent application no. PCT/CA2007/001658 entitled “Method and apparatus for assessing the characteristics of liquids” which was filed by Optosecurity Inc. et al. with the Canadian Receiving Office on Sep. 17, 2007 and which was published on Mar. 27, 2008 under publication no. WO 2008/034232. The contents of the above-referenced application are incorporated herein by reference.

In a specific example of implementation, the camera 900 is located outside the X-ray scanning device 10, such that the image of the liquid product is taken immediately before the liquid product enters the scanning tunnel and is subjected to the X-ray scanning. In such case, the camera 900 is located above and conveyor belt 114 and as soon as the liquid product passes under the camera 900 the shot is taken. Note that it may be possible to trigger the camera by any suitable detector, located near the entry of the scanning area that senses the presence of the liquid product. When the liquid product is near the entry of the scanning area and registers with the camera 900, the detector issues a signal to trigger the camera 900 that takes the shot.

The example of implementation shown in FIG. 9a would provide an image taken from a single point of view, namely from above the belt 114. To enhance the image information provided by the camera, it is possible to use two or more cameras to supplement the image with additional images from other points of view. This embodiment is shown in FIG. 9b. Note that FIG. 9b shows the liquid product and the cameras from the perspective of an observer facing the X-ray scanning apparatus 10.

The alternate arrangement uses a pair of optical cameras, 900 and 904, that take images of the container from respective points of view that are generally orthogonal to one another. In this fashion, the resulting images can be used to obtain characterization features that may not be available or may be more difficult to derive from image information obtained when a single camera is used.

In the examples described in connection with FIGS. 9a and 9b, the liquid product is shown resting directly on the belt 114. Optionally, the liquid product may be put in a tray. To allow the camera 904 to take the image from the side of the liquid product when a tray is used the tray may be made from transparent material.

(ii) Laser Scanning System Providing Container Surface Definition Data

FIG. 10 is an example of implementation using a laser scanner to obtain container characterization information in the form of surface definition data. A laser scanner uses one or more laser sources which project laser beams toward the container. Cameras sense the reflections of the laser beams and by using a triangulation algorithm determine the three dimensional coordinates of the reflection point. The output of the laser scanner 1000 is supplied to a processing module 1002 that can be separate or integrated into the module 200. The laser scanner 1000 generates container surface definition data, which in one example is a collection of three dimensional coordinates representing the surface of the container that was scanned. The container surface definition data is supplied to the processing module 1002 that derives container characterization data.

(b) Determining Container Characterization Data by a Mechanical Contact System

FIG. 11 is a side elevational view of a tray for supporting the liquid product during the X-ray scanning operation which uses a mechanical system to obtain characterization data on the container. The tray 1100 has a flat bottom portion 1102 that lays flat on the conveyor belt 114. The liquid product is placed near the center of the flat bottom portion 1102 (FIG. 11 shows the container from the side of the cap). A pair of mechanical arms 1104 and 1106, pivotally mounted on the flat bottom portion 1102, are resiliently urged against the container. The degree to which these arms 1104 and 1106 are spread apart depends on the transverse dimension of the container. It is possible to provide an arrangement of encoders (not shown) mounted on the arms to measure their angular position and communicate the angular position to the module 200 (in a wireless fashion, for example). Variants are also possible. For instance, one variant can use a third arm that is urged against the top of the container and that would allow measuring the height of the container (its height dimension being equal to its length when the container is laid on its side as shown).

(c) Determining Container Characterization Data from X-Ray Image Data

(I) From the X-Ray Image Data Conveying the Attenuation Information.

In this form of implementation, the X-ray image data is supplied to the processing module which performs an image processing operation, generally along the lines of the description in the international application WO 2008/034232 referred to earlier in order to extract container characterization data. In general, the image processing operation locates container features in the image on the basis of which certain dimensions can be computed, such as width, length, height and edge outline. The edge outline can be used to determine the profile of the container. In a specific example of implementation, the image processing operation attempts to extract perspective information on the container from the X-ray image data. In this example, the perspective information that is extracted from the X-ray image data represents depth relationships along the direction of travel of the X-rays that have produced the X-ray image. The direction of travel of X-rays is generally transverse to the image plane.

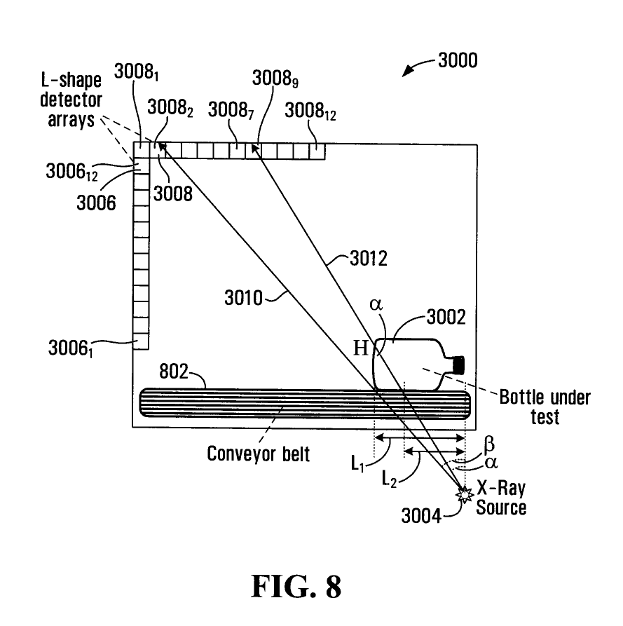

FIG. 8 illustrates in general the process for extracting perspective information from the X-ray image that contains the attenuation information. FIG. 8 is a cross-section of the X-ray imaging system 3000 showing the belt 802 on which the container 3002 is placed. For clarity, the belt 802 moves the container 3002 through the X-ray imaging system 3000 in a direction that is perpendicular to the sheet. This X-ray imaging system 3000 has a radiation source 3004 that is located below the belt 802 and also an L-shaped set of detectors that has a vertical array 3006 and a horizontal array 3008. The array 3006 is shown arbitrarily as having 12 detectors, (3006₁ . . . 3006₁₂) and the array 3008 has 12 detectors (3008₁ . . . 3008₁₂) as well. Note that in practice, X-ray imaging systems may have a higher numbers of detectors in order to provide a suitable image resolution.

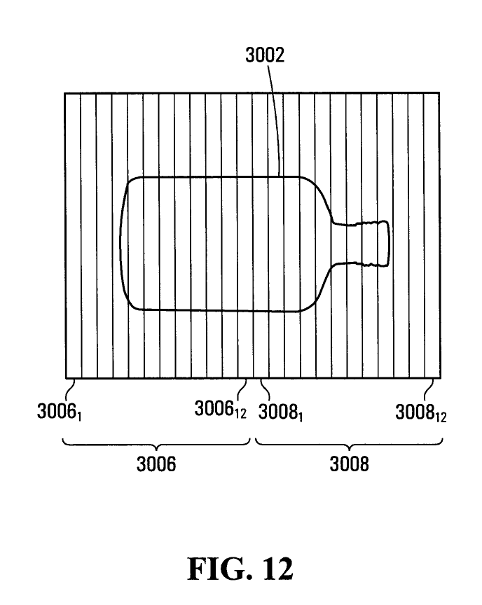

The position of the source 3004 is known and fixed. In addition, the geometry of the detector arrays 3006 and 3008 is such that it is possible to map portions of the X-ray image to individual detectors of the arrays 3006 and 3008. In other words, it is possible to tell for a certain portion of the image, which ones of the detectors produced that portion of the image. FIG. 12 provides more details in this regard. FIG. 12 shows a simulated X-ray image of a container 3002. The image is obtained as a result of a movement of the container 3002 by the belt 802 with relation to the detector arrays 3006 and 3008. Therefore, individual detectors of the arrays 3006, 3008 produce individual bands in the image. The image bands are shown in FIG. 12 and for clarity numbered with the corresponding detector reference numerals.

Referring back to FIG. 8, assume for the sake of this example that the X-ray source 3004 is turned on and generates X-ray beams that are directed through the container 3002. While there are many beams passing through the container 3002, consider only two of them, namely the beam 3010 and the beam 3012 that intersect the top and bottom edges of the container 3002. The beam 3010 will reach the detector 3008₂ while the beam 3012 will reach the detector 3008₇. By analyzing the image it is possible to determine which detectors of the arrays 3006, 3008 received the beams 3010 and 3012. Specifically, the features of the container 3002 through which the beams 3010 and 3012 pass are first located in the image and their respective positions in the image noted. In particular the processing module 200 processes the X-ray image information to locate the top and the bottom edges of the container 3002 and once those features have been identified, their position in the image is recorded. Since the image positions are mapped to corresponding detectors of the arrays 3006 and 3008, it is possible to derive which ones of the detectors in the arrays 3006, 3008 received the beams 3010 and 3012. On the basis of the position of those features in the image, the detectors are identified. Once the identity of the detectors has been found, both lengths L1 and L2 are trigonometrically calculated using angles alpha and beta. Finally, the perspective information, which in this case is the dimension H, can be simply derived by the formula H=(L₁−L₂)tan α. In this example, H would be the height of the container.

In addition to the perspective information extracted from the X-ray image data, additional container characterization data that can also be extracted from the same X-ray image data, such as approximation of container height, approximation of container width, approximation of container length, determination of profile of container, and presence or absence of certain surface features such as annular recesses in container body and position of those annular recesses and presence or absence of cap. The method for extracting the additional characterization data is discussed above briefly and detailed in the International Patent Application mentioned earlier.

(ii) From X-Ray Images Taken from Two or More Points of View

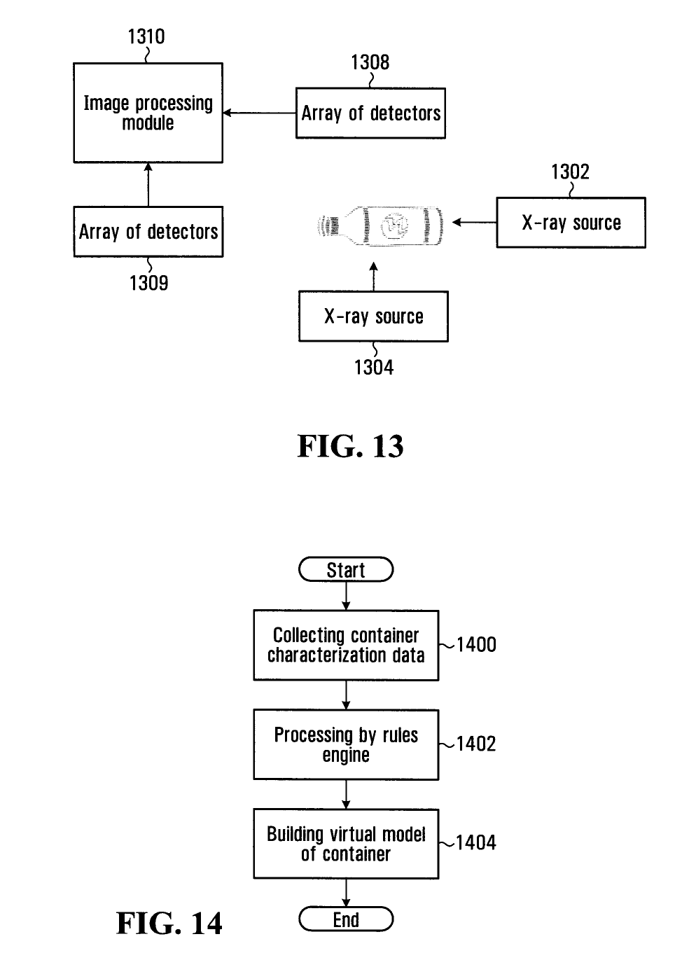

This example of implantation is schematically illustrated at FIG. 13. The figure shows schematically an X-ray scanning system 1300 which takes X-ray images from two different perspectives of the liquid product. The X-ray scanning system has two X-ray sources 1302 and 1304 and associated detectors 1306 and 1308, respectively. The output of each detector 1306 and 1308 is supplied to an image processing module 1310. The image processing module 1310, which can be a standalone component or integrated into the processing module 200 processes the X-ray image data to extract the container characterization features, such as those described earlier.

In this embodiment, one of the X-ray images can be used to gather the X-ray attenuation information. For the sake of the discussion, this could be the X-ray image taken by the source 1304 and the array of detectors 1308. In this instance, the perspective information would be available from the other X-ray image taken by the X-ray source 1302 and the array of detectors 1306. Evidently, the arrangement could be reversed; the image used to obtain the attenuation information could be the one derived from the X-ray source 1302 and the array of detectors 1306.

In the example shown, the X-ray sources 1302 and 1304 and the associated array of detectors 1306 and 1308 “look” at the container from two different angles of view, which are generally perpendicular. This does not need to be the case and it is possible to use an arrangement where the angular arrangement between the X-ray sources and array of detectors pairs is other than 90 degrees. Yet another possible arrangement is to use a single X-ray source and detector pair that are not fixed, but movable and can successively take X-ray images of the liquid product from different angles of view. Another possibility, instead of moving the X-ray source and array of detectors, the liquid product can be moved to obtain the multiple X-ray images. In this case, a first X-ray image is taken followed by a second X-ray image of the same liquid product but whose position in space is changed.

(d) Determining Spatial Extent of Container from Container Characterization Data

FIG. 14 is a flowchart of a process for determining the spatial extent of the container. In the present example, the process is implemented in software executed by the processing module 200. The first step of the process 1400 relating to the collection of characterization data was described earlier in greater detail. The container characterization data, which can be obtained through an optical camera, laser scanner, mechanical contacting means, via the X-ray image or a combination of those sources is supplied to a rules engine, as shown at step 1402. The rules engine 1402, which may include a database forms part of the processing module 200. When container characterization data is supplied to the rules engine, it will output data that is sufficiently definite to allow the creation of a virtual model of the container.

The rules engine is software that implements a series of rules that define the three dimensional structure of the container of the liquid product. The rules define certain logic which uses as an input characterization data pattern to determine what the container three dimensional shape likely is. The rules can be built in many different ways from simple logic designed to handle a limited number of container geometries to a much more complex logic that can differentiate between many different container types and geometries.

In particular, the rules engine may look for certain features that may be known to be indicative of the overall shape and/or dimensions of the container. Non-limiting examples of such features may include a removable stopping device (e.g., removable cap, cork or stopper), integral attachments (e.g., a pull tab or plastic straw), as well as the existence of certain physical features (such as recesses or ridges) and their placement relative to the top or bottom of the container.

By analyzing the characterization data to identify and confirm the existence of such features in the container, (or conversely, by confirming the lack of such features thereof) the rules engine may decide on a likely cross-sectional shape of the container or other container feature not directly observable in the X-ray image data.

In a non-limiting example, assume that the container being scanned is a plastic bottle of water with a screw-on removable cap and ridges that encircle the body of the container. Upon an initial analysis, the rules engine identifies the removable cap and the ridges. The logic or the rules engine determines that containers with those features are likely circular in cross section.

As a result of such operation, the rules engine 1402 released data that allows a three-dimensional model of the container to be generated that corresponds to its real-world counterpart. This data may include:
an indication of the general shape of the container (i.e., cylindrical), as well as how a scanned cross-section (or ‘slice’) of the container should be extruded to accurately represent the underlying container;
container dimensions, namely height, width and length data.

Typically, the general shape of a container remains unchanged even if its dimensions do change at certain points, most notably at its top or bottom extremities. However, it may be possible that a container may be formed from more than one shape, such as a perfume bottle whose bottom portion is shaped in the form of a triangular prism while its upper portion is shaped as a square cube. In addition, containers may be formed in irregular shapes, such as bottles of alcoholic spirits that are formed in the shape of polygons, such as five-pointed stars or dodecahedrons.

To handle such situations, the the rules engine 1402, may independently evaluate the characterization data generated at different points along the container under review. In this way, the rules engine can ensure that its overall interpretation of the shape of the container is valid and that the data for the three-dimensional model generated based on this conclusion will accurately represent its physical counterpart.

For example, the rules engine 1402 may interpret the characterization data for two cross-sectional segments of a container, one segment being located somewhat towards its top, while the other segment is located somewhat toward its bottom. If the same general shape (e.g., cylinder or cube) is determined through the independent analysis of the two segments, the rules engine may conclude that the overall shape of the container is indeed cylindrical throughout and then release data that allows the container to be similarly modelled. However, if the independent analysis of bottom segment indicates a different shape than that of the top segment (e.g., the bottom segment is cylindrical while the top segment is cubic), the rules engine may conclude that the overall shape of the container is not same throughout.
In such a case, it is likely that the rules engine may interpret characterization data from other cross-sectional segments of the container to verify that the container is comprised of two (or more) different shapes, and if so, locate the point at which the general shape of the container changes.

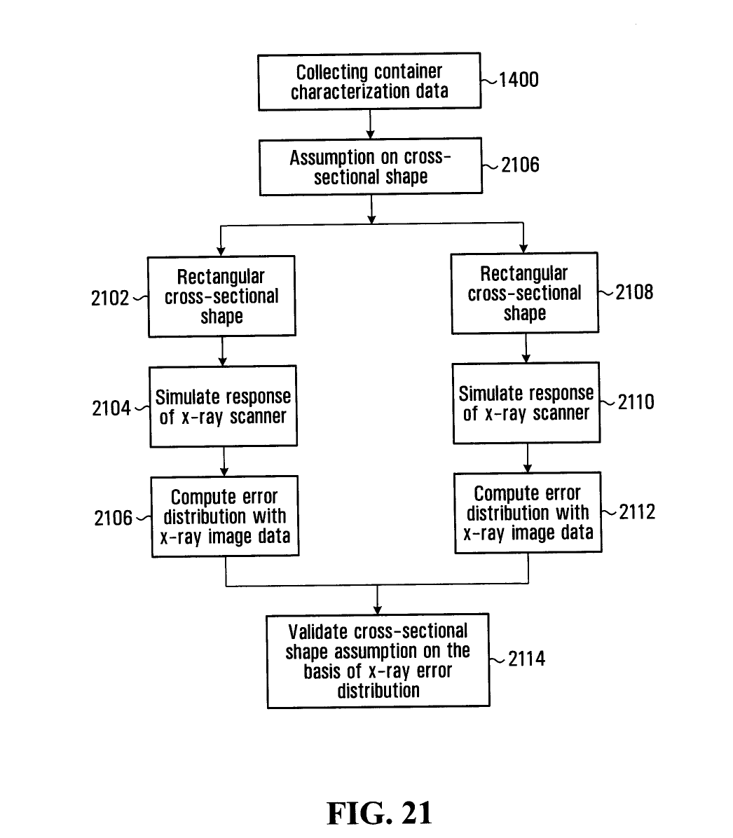

Another example of implementation of the rules engine 1402 is illustrated at the flowchart at FIG. 21. In this example, the logic works on the basis of assumptions which are subjected to a validation procedure to eliminate the options that are incorrect. More specifically, the process starts at step 1400 which was described earlier and which relates to the collection of the container characterization data. Once the container characterization data is available, the rules engine continues the processing at step 2100 on the basis of a number of assumptions as to what the cross-sectional shape of the container might be. The number of assumptions is not limiting and depends on the processing capability of the processing module 200 and the desired degree of precision to be attained.

In the example shown, two assumptions are made. The rules engine assumes first at 2102 that the container has a circular cross-sectional shape and at 2104 simulates the response of the X-ray scanner 10 to a container having the assumed cross-sectional shape (circular). The simulation process is a coarse modelling operation of the X-ray scanner 10 and aims deriving the likely X-ray attenuation data that would be obtained when a container having the assumed cross-sectional shape that holds a reference liquid, such as water for example. The simulation is, generally a three step process. During a first step a virtual model of the container is generated by the processing module 200. The generation of the virtual model of the container will be described in greater detail later. During a second step, a virtual model of the X-ray scanner is generated and the virtual model of the container placed in that model, such as to match the position of the real container in the real X-ray scanner. This process is also described in greater detail later. Given those simulated conditions, a model which simulates the interaction of X-rays with the reference liquid is run to determine what likely attenuation information would be produced. Different types of models can be used without departing from the spirit of the invention.

One example of a model that can be used is one which determines the attenuation to which the X-rays would be subjected, at different locations throughout the container on the basis of theoretical equations that map attenuation with path length, liquid characteristics and X-ray characteristics. Since the X-ray characteristics are known and the liquid characteristics are also known, only the path length needs to be determined to find the attenuation information. Path length assessment in a virtual model is discussed in greater detail later and will not be repeated here.

The attenuation information obtained via the model is then compared with the attenuation information in the X-ray image data obtained from the real X-ray scan of the liquid product. The purpose of the comparison is to determine the error distribution between the two, as identified by step 2106. The attenuation information generated by the model will likely be different from the attenuation information in the X-ray image data since the liquids are likely different. Recall that the model uses a reference liquid, such as water, while the real liquid product is filled most likely with something else. However, if the assumptions made regarding the cross-sectional shape of the container are generally correct, the attenuation error distribution will be generally uniform. On the other hand, if an incorrect cross-sectional shape has been assumed, then the error distribution will not be uniform.

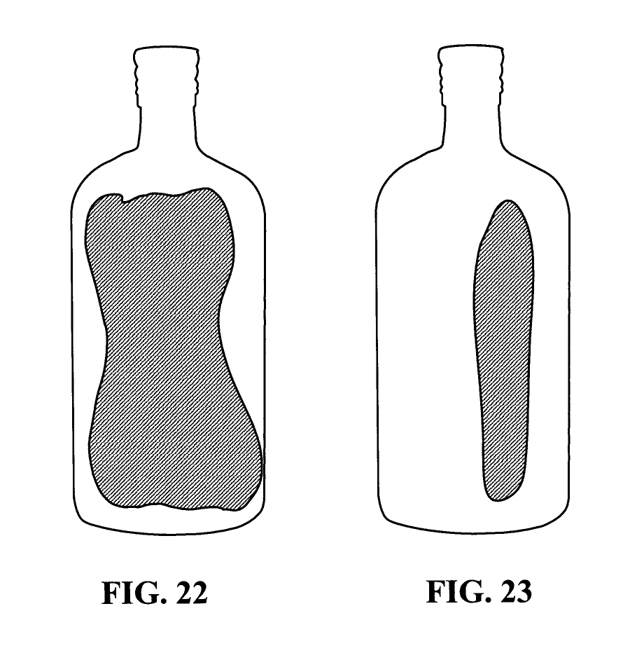

FIG. 22 is a representation of a container in which the error distribution has been mapped out within the container boundaries. In the example shown, the maximal attenuation error, which is depicted by the one with cross-hatchings, is spread generally uniformly throughout the container, indicating a relatively uniform distribution. This suggests that the assumption made for the cross-sectional shape was correct.

FIG. 23 on the other hand shows a non-uniform cross-sectional distribution, the maximal error being isolated in a relatively narrow area on the side of the container. This suggest that the assumption on the cross-sectional shape of the container was likely incorrect.

Referring back to FIG. 21, the same process is then repeated by assuming a different cross-sectional shape, say a rectangular shape (step 2108). The response of the X-ray scanner is modeled at 2110 and the attenuation error distribution established for the new cross-sectional shape at 2112.

At the validation step 2114, the various error distribution profiles are evaluated to determine the one associated with the cross-sectional shape that is most likely to be correct. The comparison operation involves comparing the error distribution and retains as the most correct shape the one in which the distribution is the most uniform.

Note that in the above example, the process used two assumptions on the cross-sectional shape of the container. The process can be modified to run with more assumptions, such as four, six, eight or more. The limiting factor is the processing capability of the processing module 200 and the degree of precision that is desired. In addition, it should also be noted that instead of making assumptions on the cross-sectional shape of the container, the assumptions can also be made on other container components, on which information is lacking and that are not directly observable in the X-ray image data. Thus, the rules engine outputs data that allows generating a virtual model of the container. In a specific example, the rules engine outputs the following:
Data specifying the container width for a number of points along the main axis of the container (the length dimension of the container)
Data specifying the cross sectional geometry and dimension of the container at each of the points above
Data specifying the coordinates of the container, such as container position and orientation.

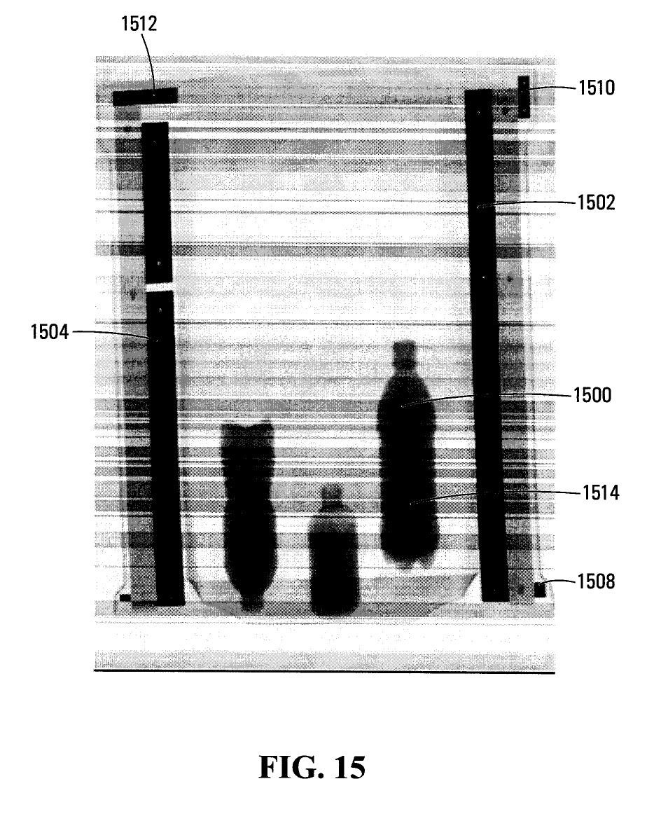

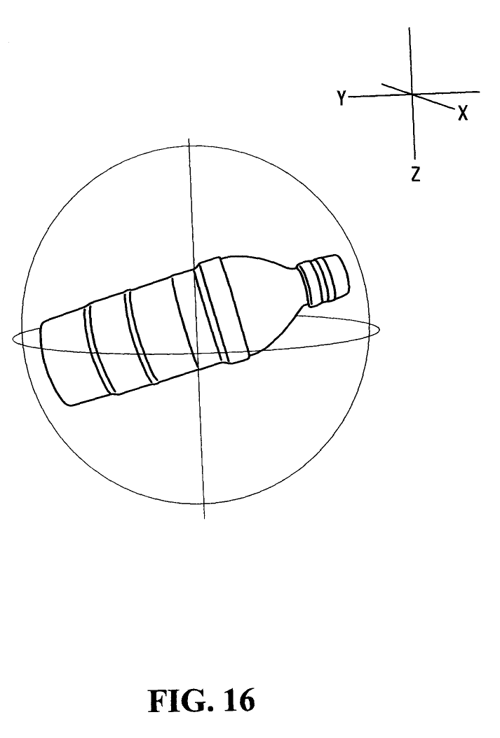

Referring back at step 1404 the output of the rules engine is supplied to a virtual model generator which will build the virtual model of the container. The virtual model generator works conceptually like an extruder in that it uses the data specifying the cross-sectional shape and then projects it along the container main axis (length), where the individual cross-sections follow the width dimensions. As a result the virtual model generator produces a three dimensional surface or solid that models the container. An example of this process is shown in FIGS. 15 and 16. FIG. 15 is an X-ray image of three liquid products. The container associated with the liquid product 1500 is processed as discussed earlier to generate a virtual model, which is shown at FIG. 16.

The spatial extent of the container and ultimately the path length can thus be determined from the virtual model.

In a possible variant, the container characterization data can be supplied to a wall thickness rules engine (not shown) that can be used to determine the type of material and wall thickness used for the manufacture of the container. Alternatively, the wall thickness can be determined directly from the X-ray image data and on the basis of the wall thickness the material that was likely used to make the container derived. For example, a thick walled container was likely made of glass while a thin walled container is likely made of plastic material.

(e) Constructing a Virtual Model of the Scanning Area

The next step of the processing includes developing a virtual model of the scanning area in which the X-ray image data, the one that conveys the X-ray attenuation information was taken. The virtual model of the scanning area is then used as context in which the virtual model of the container can be examined to determine the spatial extent of the liquid body and the length of the path followed by X-rays through the liquid body.

The virtual model of the scanning area usually would need to be generated once and can be re-used for subsequent scanning cycles since the X-ray scanner 100 does not change, hence the virtual model would be also static. The model includes the three dimensional position of a number of different components, such as:
The three-dimensional position of the X-ray source. For simplicity, the X-ray source can be expressed in the model as a single point characterized by a set of three-dimensional coordinates;
The position of the various detectors, each detector described as a single point entity characterized by a set of three dimensional coordinates;
The position of the belt, described as a surface;

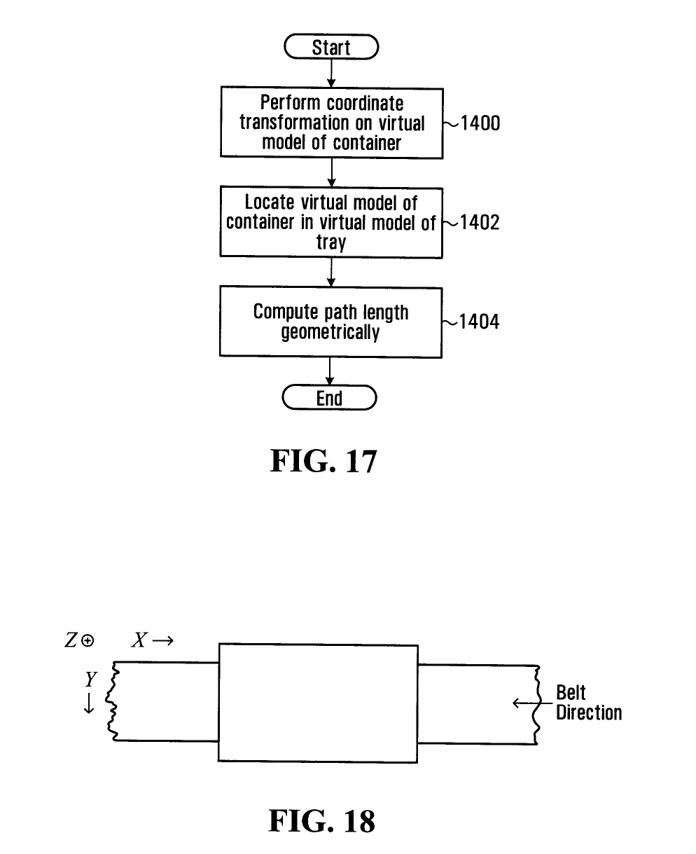

The virtual model of the container is then placed, from a computation perspective, in the virtual model of the scanning area. The ‘insertion” of the virtual model of the container is performed by locating the virtual model of the container in a position relative to the components of the virtual model of the scanning area (source, belt, etc) that corresponds to the position of the real container with relation to those real components in the real scanning area. This process is described in greater detail in the flowchart of FIG. 17.

At step 1700, the processing module 200 performs a coordinate transformation such that the virtual model of the container and the virtual model of the scanning area use a common and consistent coordinate system. In one specific example, the coordinate system of the virtual model of the X-ray scanner 100 is retained and the transformation is applied to the coordinates of the virtual model of the container. In a reverse arrangement, the transformation can be applied to the coordinates of the virtual model of the X-ray scanner 100 while the coordinates of the virtual model of the container are retained. Evidently other arrangements are possible without departing from the spirit of the invention.

One possibility is to set the coordinate system of the virtual model of the scanning area as shown in FIG. 18. In this case, the X-axis is set to be the axis along which the belt 114 moves, the Y axis is set to be the axis that is perpendicular to the belt movement direction but is within the plane of the belt and the Z axis is the axis perpendicular to the belt plane. Obviously, many other arrangements are possible.

The native coordinate system used during the creation of the virtual model of the container can be set as the coordinate system of the tray in which the liquid product is held during the X-ray scanning operation. For example, the X axis can be the longitudinal axis of the tray, the Y axis is set as the transverse axis of the image and the Z-axis is set as the axis which is perpendicular to the tray plane. In order to create a transformation from the native coordinate system of the container to the coordinate system of the virtual model of the scanning area, a transformation function is developed. The transformation function is a mathematical operation run on the coordinate system of the virtual model of the container to produce a transformed coordinate system that essentially situates the virtual model of the container relative to the coordinate system of the virtual model of the X-ray scanner 10. The transformation may involve a rotation, translation or scaling operations.

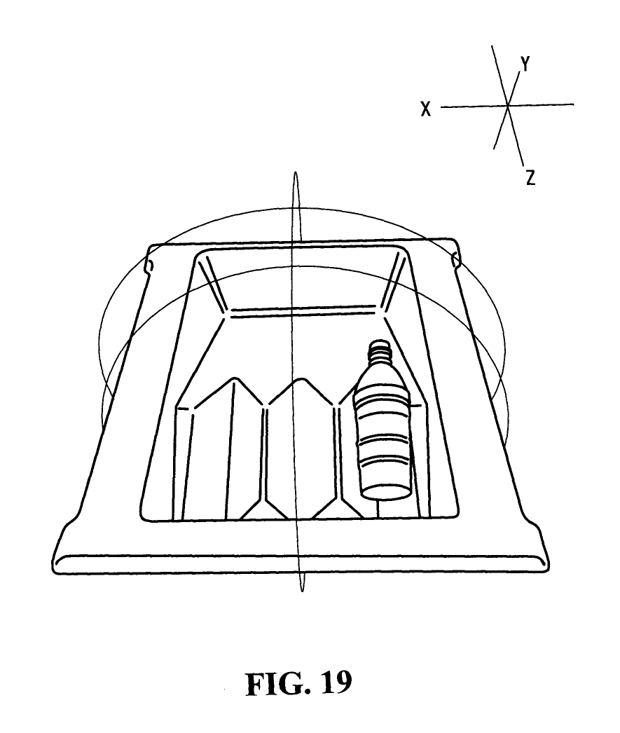

The transformation function is generated by the processing module 200 on the basis of the relationships between the tray and the coordinate system of the X-ray scanner 10. An example of a tray that can be used for that purpose is shown in FIG. 19. The tray has recesses for holding liquid products, as is shown by the image of a container.

In this example, the processing module 200 determines the position of the tray relative to the coordinate system of the X-ray scanner 10, as per the illustration of FIG. 18. The processing module 200 performs an analysis of the X-ray image to first locate the position of the tray in the image. To facilitate this operation, the tray is provided with markers that are easily recognizable in the X-ray image. FIG. 15 shows those markers. The image shows two side markers in the form of two dark rectangular bands 1502 and 1504 and four corner markers 1506, 1508, 1510 and 1512. The markers in the tray that generate the markers signature in the X-ray image are made from material that attenuates X-rays significantly and, therefore show easily in the X-ray image. The processing module 200 therefore searches the X-ray image data for the signature of the markers and when found it can compute the geometric position of the tray relative to the coordinate system of the X-ray scanner 10. At that point, the transformation function can be easily computed.

Note that the transformation function is likely to be recomputed at every scan cycle since the position of the tray, relative to the coordinate system of the X-ray scanner 100 is unlikely to be the same from one scan cycle to another.

When the transformation function is computed, the next step of the process, as shown by the flowchart at FIG. 17, is to locate the virtual model of the container into the virtual model of the X-ray scanner 10. The relocation operation is purely software based and involves shifting the position of the virtual model of the container into the virtual model of the X-ray scanner 10 such that the position matches the position of the real container in the real X-ray scanner 10.

One possibility is to locate the virtual model of the container such that it registers with a reference component in the virtual model of the X-ray scanner 10, whose position can also be established in the scanning area of the real X-ray scanner 10. The reference component can be the tray in which the liquid product is scanned.

The processing module 200 has a virtual model of the tray that it can use as a reference component for locating the virtual model of the container in the virtual model of the X-ray scanner 10. The virtual model of the tray is static in the sense that the same model is used from one scanning cycle to another. However, the location of the virtual model of the tray in the virtual model of the X-ray scanner 10 changes from one scanning cycle to another. Accordingly, for each scanning cycle, the processing module 200 recomputes the position of the virtual model of the tray in the virtual model of the X-ray scanner 10. The position of the virtual model of the tray in the Z axis is known and it corresponds to the position of the belt (the tray sits directly on the belt). In addition, the plane of the tray is parallel to the plane of the belt (the tray sits flat on the belt and it is not tilted). The processing module 200 then determines the location of the tray in the X-Y plane and the orientation of the tray in that plane. This is done via the determination of the position of the tray in the X-ray image discussed earlier. The processing module processes the X-ray image data to identify the signatures of the tray markings and can, therefore determine the position of the tray in the X-Y plane and its orientation in that plane.

After the processing is completed, the processing module 200 locates the virtual model of the tray in the virtual model of the X-ray scanner 10 until the virtual model of the tray is within the computed tray position for the scanning cycle.

With the reference component now in the proper position in the virtual model of the X-ray scanner 10, the processing module 200 adjusts the position of the virtual model of the container such that it registers with the tray. More particularly, the positioning includes locating the two virtual objects such that they are one on top of the other with the outside surfaces in contact (to simulate physical contact), without any interpenetration. The relative positioning is such that the virtual model of the container adopts the same position relative to the virtual model of the tray than the real container sitting in the real tray.

When the positioning of the virtual model of the container relative to the virtual model of the tray is completed, the virtual model of the scanning area, as it has been set, accurately simulates the condition of the X-ray machine 10 during the scanning cycle. More specifically, the simulation locates in three dimensions the scanned object (liquid product) with relation to the components of the X-ray scanner 10, in particular the X-ray source and the array of detectors and belt, among others.

(f) Computation of Path Length

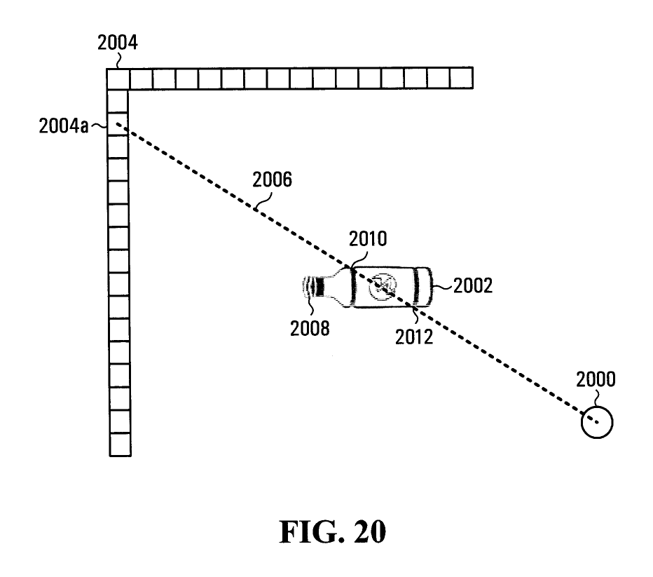

The path length computation is done in a simulated environment, namely the virtual model of the scanning area as set for the particular scanning cycle. The path length computation is illustrated and will be described in connection with FIG. 20. The illustration is a simplified rendering of the virtual model of the scanning area of the X-ray scanner 10, showing the X-ray source 2000, the container 2002 and the array of detectors 2004. The other elements of the virtual model of the scanning area are not shown for simplicity.

Assume that in the X-ray image, the attenuation information which reflects the interaction between the X-rays and liquid in the container appears in the area 1514 of the image (see FIG. 15). As discussed in connection with FIG. 8, it is possible to determine on the basis of the image portion 1514 the detector in the array of detectors 2004 that has output the attenuation information in that image portion. For the sake of this example assume that the particular detector is 2004a. Since the three dimensional coordinates of the detector 2004a are well known in the virtual model of the X-ray scanner 10, it is possible to determine a path of travel of X-rays that have interacted with the liquid and produced the attenuation information at 1514, between the coordinates of the detector 2004 and the position of the X-ray source 2000. The X-ray propagation path is shown at 2006. The path is represented as a straight line between the two points, intercepting the virtual model of the container 2008.

The intersection points 2010 and 2012 between the surface defining the virtual model of the container 2008 and the X-ray propagation path 2006 are computed by the processing module 200 by using geometry algorithms. When the three dimensional coordinates of these points are known, the straight line distance between them is computed. The straight line distance is the length of the path followed by the X-rays through the liquid body that have produced the attenuation information at area 1514.

Certain refinements are possible without departing from the spirit of the invention. The above computation of the path length assumes that the wall thickness of the container 2008 is negligible. This may be case for certain types of containers that have thin walls, such as containers made of plastic material. For other types of containers, such as containers made of glass material or other material using thicker walls, the computed path length can be corrected to take into account the wall thickness.

3) Determining Threat Status

The determination of the threat status is done by computing certain properties of the liquid body on the basis of the attenuation information and the path length. Examples of those computations can be found in the International patent is application referred to earlier.

Although various embodiments have been illustrated, this was for the purpose of describing, but not limiting, the invention. Various modifications will become apparent to those skilled in the art and are within the scope of this invention, which is defined more particularly by the attached claims.

1) A method for determining if a liquid product comprising a container which holds a body of liquid is a security threat, the method including:
a) receiving X-ray data derived by scanning the liquid product with X-rays in a scanning device, the X-ray data conveying information about attenuation of X-rays resulting from interaction of X-rays with the body of liquid;
b) modelling a position of the liquid product with respect to either one of an X-ray source and an X-ray detector of the scanning device;
c) processing the modeled position to compute path length data, the path length data being indicative of an approximate length of a path followed by X-rays through the body of liquid and that interact with the body of liquid; and
d) processing the path length data and the X-ray data to determine if the liquid product is a security threat.

2) Method for determining if a liquid product comprising a container which holds a body of liquid is a security threat, the method including:
a) receiving X-ray data derived by scanning the liquid product with X-rays using a scanning device, the X-ray data conveying a two-dimensional representation of the liquid product and providing information about attenuation of X-rays resulting from interaction of X-rays with the body of liquid;
b) deriving container characterization data on the basis of the X-ray data;
c) processing the container characterization data to derive path length data, the path length data being indicative of an approximate length of a path followed by X-rays through the body of liquid and that interact with the body of liquid;
d) processing the path length data and the X-ray data to determine if the liquid product is a security threat.

3) A method as defined in claim 1, said method further comprising:
a) deriving container characterization data;
b) processing the container characterization data to model the position of the liquid product with respect to either one of the X-ray source and the X-ray detector of the scanning device.

4) A method as defined in claim 3, wherein deriving the container characterization data is performed before the scanning.

5) A method as defined in claim 3, wherein deriving the container characterization data includes receiving measurements obtained by contacting the container with a mechanical component.

6) A method as defined in claim 3, wherein deriving the container characterization data includes receiving measurements obtained using a non-contact measurement system.

7) A method as defined in claim 6, wherein the non-contact measurement system includes an optical camera.

8) A method as defined in claim 6, wherein the non-contact measurement system includes a laser scanner to optically capture the shape of the container.

9) A method as defined in claim 3, wherein deriving the container characterization data includes processing the X-ray data.

10) A method as defined in claim 9, wherein the X-ray data is generated by placing the liquid product on a conveyor belt of the scanning device and scanning the liquid product with X-rays as the liquid product is being displaced by the conveyor belt.

11) A method as defined in claim 10, wherein the X-ray data conveys an X-ray image of the liquid product, the method including processing the X-ray data to extract container perspective data, the perspective data conveying information about the spatial extent of the container in a direction along which X-rays interacting with the body of liquid propagate therethrough.

12) A method as defined in claim 11, including the step of processing the perspective data to extract information about a cross-sectional shape of the container.

13) A method as defined in claim 3, including processing the container characterization data to derive information about a cross-sectional shape of the container.

14) A method as defined in claim 13, including generating a virtual model of the container.

15) A method as defined in claim 14, including computationally manipulating the virtual model to locate the virtual model in a virtual model of the X-ray machine used for the scanning, the X-ray machine including an X-ray source and an X-ray detector.

16) A method as defined in claim 15, including computationally manipulating the virtual model of the container to locate the virtual model of the container in a position relative to a virtual source of X-rays, the position corresponding to a position of the real container relative to a real source of X-rays during the scanning.

17) A method as defined in claim 16, including computing intersection points of X-rays through the virtual model of the container on the basis of the position of the virtual model with relation to the virtual source of X-rays.

18) A method as defined in claim 17, including processing the intersection points to generate the path length data.

19) A method as defined in claim 16, computationally manipulating the virtual model of the container to register the virtual model of the container with a virtual model of a reference element that defines a reference position of the real container with relation to the real source of X-rays.

20) A method as defined in claim 19, wherein the virtual model of the reference element includes a virtual model of a tray for supporting the liquid product during the scanning.

21) A method as defined in claim 10, including processing the X-ray data to extract information about a wall thickness of the container.

22) A method as defined in claim 9, wherein the X-ray data includes:
a) first X-ray image data derived by performing a first scanning of the liquid product with X-rays and conveys an image of the liquid product from a first point of view; and
b) second X-ray image data derived by performing a second scanning, the second X-ray image data conveying an image of the liquid product from a second point of view.

23) A method as defined in claim 22, including deriving the information about the spatial extent of the container from the second X-ray image data.

24) A method as defined in claim 23, wherein the first point of view and the second point of view are generally along orthogonal directions.

25) An apparatus for determining if a liquid product comprising a container which holds a body of liquid is a security threat, the apparatus including:
a) a scanning device for scanning the liquid product with X-rays to derive X-ray data, the X-ray data conveying information about attenuation of X-rays resulting from interaction of X-rays with the body of liquid;
b) a processing element having an input in communication with said device and being programmed for:
i) modeling a position of the liquid product with respect to either one of an X-ray source and an X-ray detector in the scanning device;
ii) processing the modeled position to compute path length data, the path length data being indicative of an approximate length of a path followed by X-rays through the body of liquid and that interact with the body of liquid; and
iii) processing the path length data and the X-ray data to determine if the liquid product is a security threat;
c) an output for releasing data conveying results obtained by the processing element.

26) A computer readable storage medium storing a program element for execution by a computing device for determining if a liquid product comprising a container which holds a body of liquid is a security threat, said program element when executing on said processor implementing a method comprising:
a) receiving X-ray data derived by scanning the liquid product with X-rays in a scanning device, the X-ray data conveying information about attenuation of X-rays resulting from interaction of X-rays with the body of liquid;
b) modelling a position of the liquid product with respect to either one of an X-ray source and an X-ray detector of the scanning device;
c) processing the modeled position to compute path length data, the path length data being indicative of an approximate length of a path followed by X-rays through the body of liquid and that interact with the body of liquid; and
d) processing the path length data and the X-ray data to determine if the liquid product is a security threat.

27) An apparatus for determining if a liquid product comprising a container which holds a body of liquid is a security threat, the apparatus including:
a) an input for receiving container characterization data;
b) a computer based processing component for:
i) modeling a position of the liquid product with respect to either one of an X-ray source and an X-ray detector;
ii) processing the modeled position to compute path length data, the path length data being indicative of an approximate length of a path followed by X-rays through the body of liquid and that interact with the body of liquid;
iii) processing the path length data and the container characterization data for determining if the liquid product is a security threat; and
c) an output for releasing data conveying the result of the determining.

28) Method for determining a length of a path followed by X-rays through a body of liquid held in a container, the method including:
a) scanning the container with X-rays to generate X-ray image data;
b) modeling a position of the container with respect to either one of an X-ray source and an X-ray detector;
c) deriving the length of the path of X-rays through the body of liquid held in the container at least in part based on the modelled position of the container.

29) A method as defined in claim 28, wherein modeling the position of the container includes extracting container characterization data from X-ray image data.

30) A method as defined in claim 29, wherein the characterization data includes container width information.

31) A method as defined in claim 29, wherein the characterization data includes container height information.

32) A method as defined in claim 29, wherein the container characterization data indicates whether or not that the container has a cap.

33) Method for determining if a liquid product comprising a container which holds a body of liquid is a security threat, the method including:
a) receiving X-ray data derived by scanning the liquid product with X-rays, the X-ray data conveying information about attenuation of X-rays resulting from interaction of X-rays with the body of liquid;
b) generating a virtual model of the container by using software executed by a computer;
c) processing the virtual model and the X-ray data to determine if the liquid product is a security threat.

34) A method as defined in claim 33, including deriving container characterization data and processing the container characterization data with the computer to generate the virtual model of the container.

35) A method as defined in claim 34, including computationally manipulating the virtual model to locate the virtual model in a virtual model of the X-ray machine used for the scanning, the X-ray machine including an X-ray source and an X-ray detector.

36) A method as defined in claim 35, including computationally manipulating the virtual model of the container to locate the virtual model of the container in a position relative to a virtual source of X-rays, the position corresponding to a position of the real container relative to a real source of X-rays during the scanning.

37) A method as defined in claim 36, including computing intersection points of X-rays through the virtual model of the container on the basis of the position of the virtual model with relation to the virtual source of X-rays.

38) A method as defined in claim 37, including processing the intersection points to generate path length data.

39) A method as defined in claim 36, computationally manipulating the virtual model of the container to register the virtual model of the container with a virtual model of a reference element that defines a reference position of the real container with relation to the real source of X-rays.

40) A method as defined in claim 39, wherein the virtual model of the reference element includes a virtual model of a tray for supporting the liquid product during the scanning.

41) A method as defined in claim 34, wherein deriving container characterization data includes processing the X-ray data derived by scanning the liquid product with X-rays.

42) A method as defined in claim 34, wherein the characterization data includes container width information.

43) A method as defined in claim 34, wherein the characterization data includes container height information.

44) A method as defined in claim 35, wherein the container characterization data indicates whether or not that the container has a cap.

45) An apparatus for determining if a liquid product comprising a container which holds a body of liquid is a security threat, the apparatus comprising:
a) a device for scanning the liquid product with X-rays to derive X-ray data, the X-ray data conveying information about attenuation of X-rays resulting from interaction of X-rays with the body of liquid; and
b) a processing element having an input in communication with said device and being programmed for
i) receiving the X-ray data;
ii) generating a virtual model of the container;
iii) processing the virtual model and the X-ray data to determine if the liquid product is a security threat.

46) A computer readable storage medium storing a program element for execution by a computing device for determining if a liquid product comprising a container which holds a body of liquid is a security threat, said program element when executing on said processor implementing a method comprising:
a) receiving X-ray data derived by scanning the liquid product with X-rays, the X-ray data conveying information about attenuation of X-rays resulting from interaction of X-rays with the body of liquid;
b) generating a virtual model of the container;
c) processing the virtual model and the X-ray data to determine if the liquid product is a security threat.
